(19) United States
(12) Patent Application Publication
(10) Pub. No.: US 2019/0322233 A1
(43) Pub. Date: Oct. 24, 2019

(54) Controlling Airbag Activation Status At A Motor Vehicle

(71) Applicant: Ford Global Technologies, LLC, Dearborn, MI (US)

(72) Inventor: Jorge Suarez Rivaya, Mountain View, CA (US)

(21) Appl. No.: 15/961,661

(22) Filed: Apr. 24, 2018

(51) Int. Cl. B60R 21/015

(52) U.S. Cl. CPC B60R 21/01538; B60R 21/16

(57) ABSTRACT

The present invention extends to methods, systems, and computer program products for controlling airbag activation status at a motor vehicle. Aspects of the invention can detect if a passenger in a motor vehicle is traveling in a less safe position, for example, with his/her feet on the dashboard. If so, an airbag can be deactivated and the passenger can be notified to modify his/her position. Based on images from a first camera, a control unit detects an object in the passenger seat as a human adult or not a human adult. Based on images from a second camera, the control unit detects the presence of legs/feet in a foot well or detects that legs/feet are not present in the footwell. If an object is detected as not a human adult or not having legs/feet in the foot well, the control unit can deactivate an airbag deployment device.

### CROSS-REFERENCE TO RELATED APPLICATIONS

Not applicable.

### BACKGROUND

### 1. Field of the Invention

This invention relates generally to the field of motor vehicle safety, and, more particularly, to controlling airbag activation status at a motor vehicle.

### 2. Related Art

Many front seat passengers in motor vehicles ride with their feet elevated on top of the dashboard. Riding with feet elevated on the dashboard is dangerous and is also against the law in some countries. Many vehicles have an airbag situated under the dashboard. If the airbag deploys, the airbag can send the passengers legs against their body and/or face (instead of protecting their thorax and face from impacting the dashboard). Further, in the event of a crash, the human body tends to slide under the seat belt (the “Submarine Effect”). Car seats are designed to reduce sliding under the seat belt. However, if feet are placed over the dashboard, the human body more easily slides under the seat belt and into the dashboard.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2A illustrates an example side view of a front passenger area of a vehicle.

FIG. 2B illustrates an example side view of a front passenger area of a vehicle with a person sitting in a proper position.

FIG. 2C illustrates an example side view of a front passenger area of a vehicle with a person sitting in an improper position.

FIG. 3 illustrates a flow chart of an example method for controlling airbag activation at a motor vehicle.

FIG. 4 illustrates an example data flow between sensors, a learning system, and airbag activators.

### DETAILED DESCRIPTION

The present invention extends to methods, systems, and computer program products for controlling airbag activation at a motor vehicle.

Having one's feet on the dashboard of a motor vehicle is considered an incorrect and unsafe traveling position. A correct traveling position is sitting with the feet on the floor and the back essentially fully resting on the backrest of the seat.

In general, aspects of the invention use visual inputs, computer vision, and deep learning techniques to detect if a passenger in a motor vehicle has his/her feet on the dashboard or is otherwise traveling in an unsafe position. More particularly, a passenger's position can be identified based in part on images from cameras and/or data from pressure sensors on the dashboard or floor. When a passenger is detected traveling in an unsafe position, an airbag deployment device can be deactivated. A warning system can also notify the passenger to correct his/her seating position. For example, audible and/or visual alerts can be presented inside a vehicle cabin to suggest modification.

In one aspect, a control unit detects an object in the passenger seat as a human adult or not a human adult based on images from a first camera. Examples of things that are not human adults are human children, boxes, and other objects. If the object is detected as not a human adult, the control unit can deactivate an airbag deployment device. The control unit detects the presence of legs and/or feet in a foot well in front of the seat or detects that legs and/or feet are not present in the footwell based on images from a second camera. Examples of legs not being in the footwell are no objects in the footwell or objects other than legs in the footwell. Based on the presence or non-presence of legs in the footwell, the control unit detects the sitting posture of the passenger and/or that the person sitting in the passenger seat is an adult or non-adult. If the passenger is detected in an unsafe posture or the if the passenger is detected to be a non-adult, the control unit can deactivate the airbag deployment device.

In a further aspect, a vehicle dashboard is equipment with one or more pressure sensors to detect objects (e.g., feet) on the dashboard. If an object is detected on the dashboard, the control unit can deactivate the airbag deployment device.

When a passenger is traveling in an unsafe position, deactivating an airbag deployment device may increase passenger safety (e.g., avoiding an airbag driving the legs of the passenger into his/her thorax and/or head).

Along with deactivating an airbag deployment device, the control unit can output audible and/or visual alerts in the vehicle cabin to notify a passenger to change his/her posture to a safer position. Based on images from the first and second cameras and possibly sensor data from a pressure sensor, the control unit can detect if the passenger adjusts his/her posture back to a safer position. When a safer position is detected, the control unit can (re)activate an airbag deployment device. The control unit may repeatedly deactivate and/or activate the airbag deployment device as a passenger's posture changes.

If the control unit detects a child, the control unit deactivates the airbag deployment device even if feet are detected in the foot well.

The control unit can use one or more neural networks (e.g., convolution neural networks) to facilitate detections. As such, an array of sensors (e.g., one or more cameras and one or more pressure sensors) can monitor a passenger seat and objects present in the passenger seat. When an object is present in the passenger seat, the array of sensors senses the object and sends sensor data to the one or more neural networks. The one or more neural networks classify the object as human or not human. If the object is classified as human, the one or more neural networks classify the person as an adult (and thus large enough to safely sustain airbag deployment) or as a non-adult. If the object is classified as a non-adult, an airbag deployment device is deactivated. If the object is classified as an adult, the one or more neural networks classify the traveling position as safe or unsafe. If the traveling position is classified as unsafe, the airbag deployment device is deactivated and audible and/or visual alerts can be output in the motor vehicle's cabin.

Accordingly, deep learning and/or neural network techniques can identify passenger position based in part on data from cameras and/or pressure sensors on the dashboard and/or floor. A warning system can notify passengers to correct seating position.

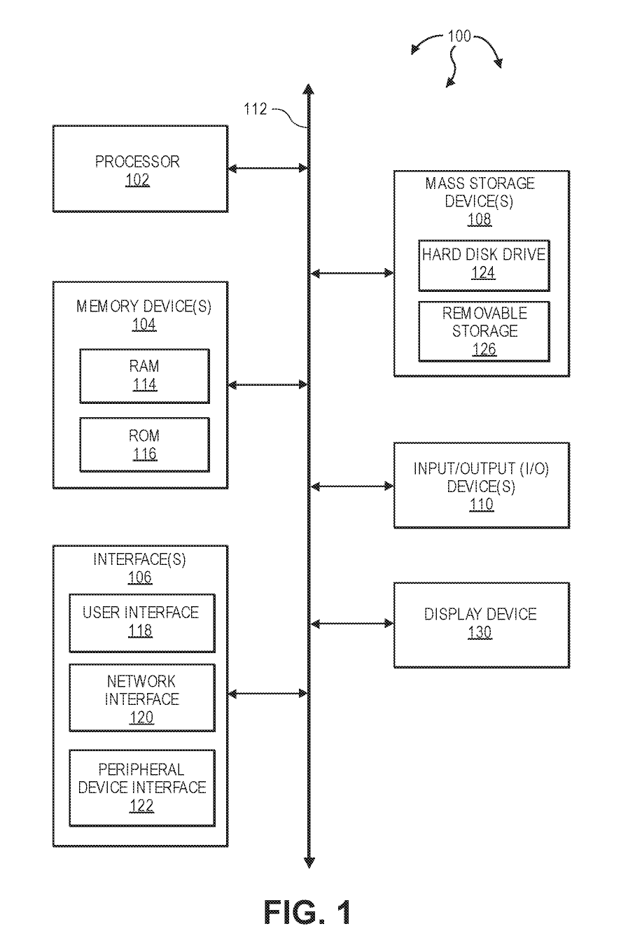

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, radars, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

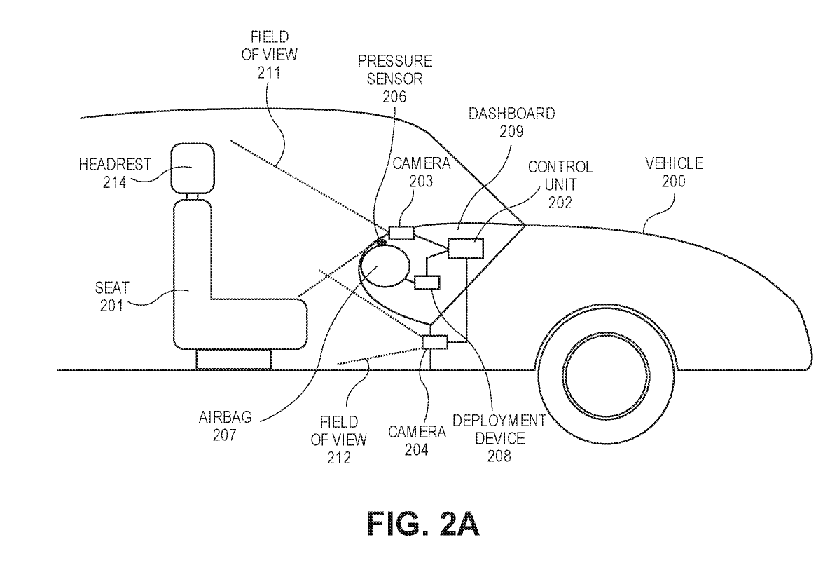

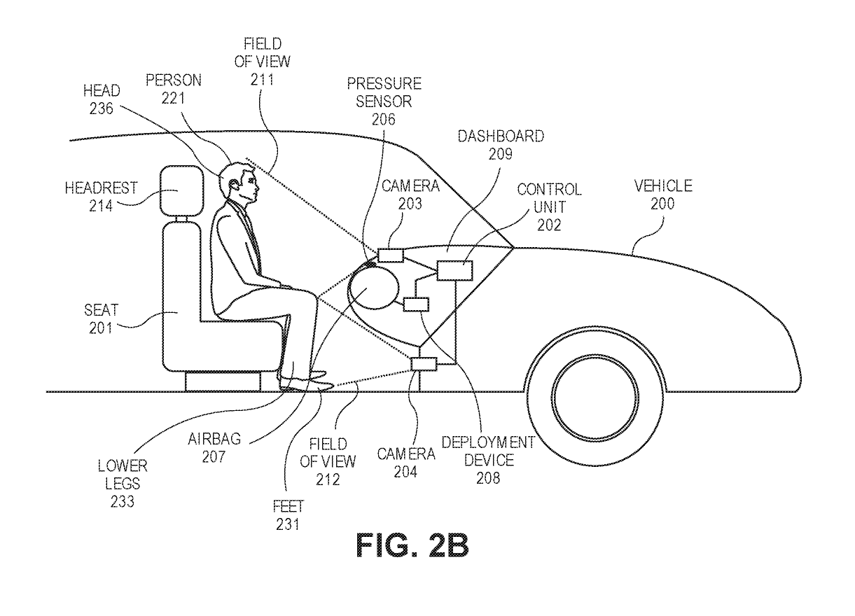

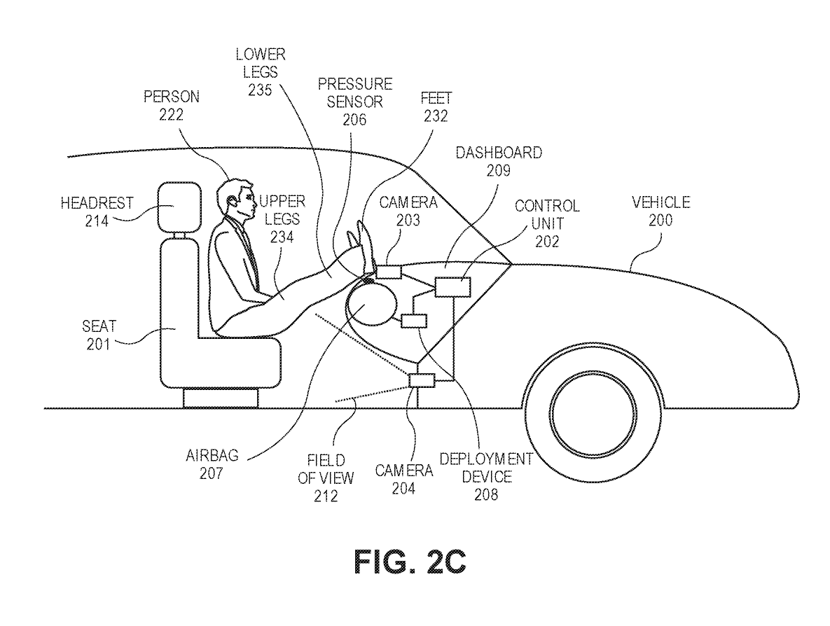

FIG. 2A illustrates an example side view of a front passenger area of vehicle 200. As depicted, vehicle 200 includes (e.g., passenger) seat 201 and dashboard 209. Camera 203, pressure sensor 206, and airbag 207 are located in dashboard 209. Camera 204 is located under dashboard 209. Control unit 202 and airbag deployment device 208 can be located in dashboard 209 or elsewhere in vehicle 200.

Camera 203, camera 204, pressure sensor 206, control unit 202, and airbag deployment device 208 can be connected to one another over (or be part of) a network, such as, for example, a PAN, a LAN, a WAN, a controller area network (CAN) bus, and even the Internet. Accordingly, each of camera 203, camera 204, pressure sensor 206, control unit 202, and airbag deployment device 208 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

As depicted, camera 203 has field of view 211. Field of view 211 allows camera 203 to monitor an upper portion of seat 201. Camera 204 has field of view 212. Field of view 212 allows camera 204 to monitor a lower portion of seat 201 (e.g., in and around the front passenger side footwell of vehicle 200).

Airbag deployment device 208 controls the deployment of airbag 207. When airbag deployment device 208 is activated, airbag 207 can deploy (e.g., in a collision). When airbag deployment device 208 is deactivated, airbag 207 is prevented from deploying (even in a collision). In general, control unit 202 receives images and/or sensor data from cameras 203 and 204 and/or pressure sensor 206. Based on the images and/or sensor data, control unit 202 activates or deactivates airbag deployment device 208.

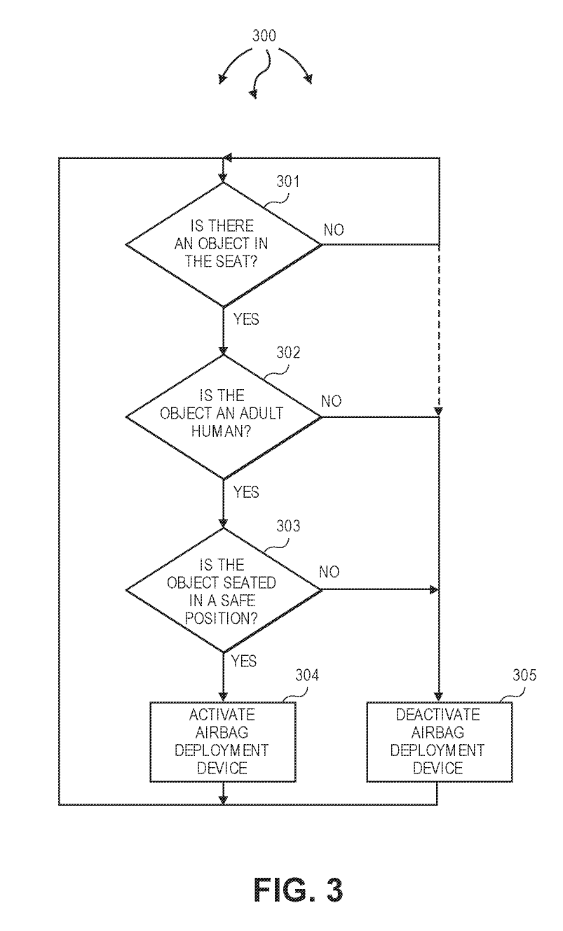

FIG. 3 illustrates a flow chart of an example method 300 for controlling airbag activation at a motor vehicle. FIG. 2B illustrates an example side view of a front passenger area of vehicle 200 with person 221 sitting in a proper (and safer) position. FIG. 2C illustrates an example side view of a front passenger area of a vehicle 200 with person 222 sitting in an improper (and less safe) position. Method 300 will be described with respect to the components at vehicle 200.

Method 300 includes detecting if there is an object in a seat (301). For example, control unit 202 can detect if there is an object in seat 201. In general, cameras 203 and 204 can stream images to control unit 202 and pressure sensor 206 can send sensor data to control unit 202. From the image streams and/or sensor data, control unit 202 can detect whether or not an object is in seat 201. For example, in FIG. 2A, cameras 203 and 204 can stream images of unoccupied seat 201 to control unit 202. Pressure sensor 206 can send sensor data indicating nothing on top of dashboard 209 to control unit 202. Based on the streamed images and sensor data, control unit 202 does not detect an object in seat 201.

In FIG. 2B, cameras 203 and 204 can stream images of person 221 sitting in seat 201 to control until 202. Pressure sensor 206 can send data indicating nothing on top of dashboard 209 to control unit 202. Based on the streamed images and sensor data, control unit 202 detects an object in seat 201.

In FIG. 2C, camera 203 can stream images of the bottom of feet 232 or, if covered by feet 232, can stream partially or fully blacked out images to control unit 202. Camera 204 can stream images of a mostly empty area in the foot well in front of seat 201 along with some part of the back of upper legs 234 to control unit 202. Pressure sensor 206 can send data indicating that there is something on top of dashboard 209 to control unit 202. Based on the streamed images and sensor data, control unit 202 detects an object in seat 201.

When an object is not detected in the seat (NO at 301), method 300 can return to 301. Controller 202 can process image streams and pressure sensor data at specified intervals (e.g., every 5 to 10 seconds). Controller 202 can also check the status of airbag deployment device 208. If airbag deployment device 208 is deactivated, control unit 202 waits for the next specified interval. On the other hand, if airbag deployment device 208 is activated, control unit 202 sends a deactivation signal to airbag deployment device 208 to deactivate airbag deployment device 208 (305). Control unit 202 then waits for the next specified interval.

When an object is detected in the seat (YES at 301), method 300 includes detecting if the object is an adult human (302). For example, control unit 202 can detect if an object in seat 201 is an adult human. In FIG. 2B, control unit 202 detects that the object (i.e., person 221) is an adult human based on images streamed from camera 203. In one aspect, control unit 202 determines that person 221 is an adult human based on the height of head 236 relative to the height of seat 201 (i.e., person 221 is of “adult-like” height). For example, if head 236 blocks more than a threshold amount or percentage of head rest 214 from the view of camera 203, control unit 202 classifies person 221 as an adult human.

On the other hand, if head 236 blocks less than the threshold amount or percentage of head rest 214 from the view of camera 203, control unit 202 classifies person 221 as not a human adult (i.e., person 221 is not of “adult-like” height). If head rest 214 is fully exposed to the view of camera 203, control unit classifies person 221 as not a human adult. An object classified as not a human adult, may be a human child, a box, a pet, etc.

In FIG. 2C, control unit 202 may not have previously classified person 222. Control unit 202 can detect that person 222 is not a human adult based on images streamed from cameras 203 and 204 and sensor data from pressure sensor 206. For example, images from camera 203 can be partially or fully obscured by feet 232 and/or lower legs 235, sensor data from pressure sensor 206 can indicate that an object is resting on dashboard 209, and images from camera 204 can indicate part of upper legs 234 but do not indicate the presence of lower legs or feet of a human. As such, control unit is unable to classify person 222 as a human adult.

Alternately, person 221 and person 222 may be the same person. Initially, control unit 202 may have detected the person as a human adult, for example, when the person was sitting as depicted in FIG. 2B. Subsequently, the person can adjust to the traveling position depicted in FIG. 2C. Control unit 202 can retain knowledge that the person was previously classified as a human adult.

When a detected object is classified as not a human adult (NO at 302), method 300 includes deactivating the airbag deployment device (305). For example, control unit 202 can send a deactivation signal to airbag deployment device 208 to deactivate airbag deployment device 208. Method 300 can then return to 301.

On the other hand, when a detected object is classified as a human adult (YES at 302), method 300 includes detecting if the object is seated in a safe position (303). For example, control unit 202 can detect if an object in seat 201 is seated in a safe position. In FIG. 2B, control unit 202 detects that the object (i.e., person 221) is seated in a safer position based on images streamed from cameras 203 and 204 and sensor data from pressure sensor 206. For example, images from camera 203 can indicate that the upper torso of person 221 is properly in seat 201. Images from camera 204 can indicate the presence of lower legs 233 and feet 231 in the foot-well of vehicle 200. Sensor data from pressure sensor 206 can indicate that no object is present on dashboard 209.

In FIG. 2C, control unit 202 detects that the object (i.e., person 222) is seated in a less safe position based on images streamed from cameras 203 and 204 and sensor data from pressure sensor 206. For example, images from camera 203 can indicate that lower legs 235 and/or feet 232 are at least partially blocking camera 203. Images from camera 204 can indicate lower legs and/or feet are not present in the foot-well of vehicle 200. Sensor data from pressure sensor 206 can indicate that an object is present on dashboard 209.

When an object is not seated in a safe position (NO at 303), method 300 includes deactivating the airbag deployment device (305). For example, control unit 202 can send a deactivation signal to airbag deployment device 208 to deactivate airbag deployment device 208 based on the posture of person 221. Method 300 can then return to 301. On the other hand, when an object is seated in a safe position (YES at 303), method 300 includes activating the airbag deployment device (304). For example, control unit 202 can send an activation signal to airbag deployment device 208 to activate airbag deployment device 208 based on the posture of person 221. Method 300 can then return to 301.

When airbag deployment device 208 is activated, airbag 207 can deploy under conditions (e.g., a collision) warranting deployment of airbag 207 (i.e., airbag 207 is “turned on”). When airbag deployment device 208 is deactivated, airbag 207 does not deploy even under conditions that otherwise warrant deployment of airbag 207 (i.e., airbag 207 is “turned off”).

Further, when an object (passenger) is in a less safe position, control unit 202 can send a warning to alert a passenger to sit in a safer position. For example, control unit 202 can send an audio warning or alert through the sound system of vehicle 200. Alternately or in combination, a control unit 202 can render a visual warning or alert on a display device in vehicle 200. As an extension and/or alternative to an audio alert, a visual alert showing a safer (or correct) traveling position may be displayed using an in-vehicle infotainment (IVI) system.

After airbag deployment device 208 is deactivated, control unit 202 may later detect person 222 in a safe position (e.g., through a subsequent iteration of method 300). For example, person 222 can remove feet 232 from dash board 209 and place them in the foot well of vehicle 200. In response, control unit 202 can send an activation signal to airbag deployment device 208 to (re)activate airbag deployment device 208.

If control unit 202 again detects that person 222 is in an unsafe position (e.g., through a further iteration of method 300), control unit 202 can send a deactivation signal to airbag deployment device 208 to again deactivate airbag deployment device 208. Thus, as person 222 moves between traveling positions in seat 201, control unit 202 can detect when person 222 is seated in less safe position and alert person 222 to move into a safer position. Control unit 202 can activate and deactivate airbag deployment device 208 as person 222 transitions between safer seating positions and less safe seating positions respectively.

In some aspects, control unit 202 includes one or more neural networks (e.g., one or more convolution neural networks) for classifying objects, such as, for example, as a human adult or not a human adult, as riding in a safe position or not riding in safe position, etc.

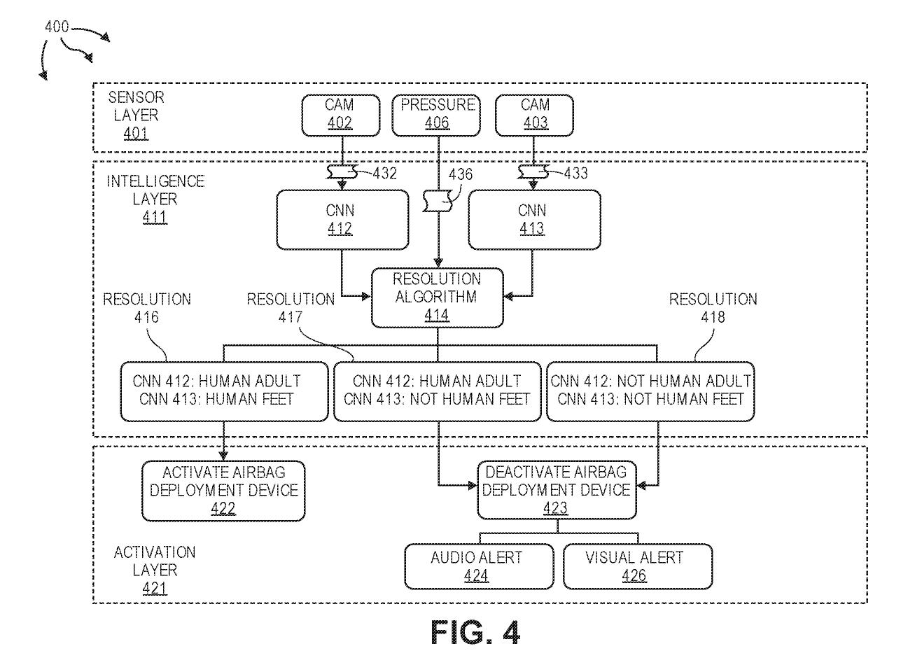

FIG. 4 illustrates an example data flow 400 between sensors, a learning system, and airbag activators. As depicted, data flow 400 includes sensor layer 401, intelligence layer 411 (e.g., in control unit 201), and activation layer 421. Components in sensor layer 401, intelligence layer 411, and activation layer 421 can be connected to one another over (or be part of) a network, such as, for example, a PAN, a LAN, a WAN, a controller area network (CAN) bus, and even the Internet. Accordingly, components in each of sensor layer 401, intelligence layer 411, and actuation layer 421 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Sensor layer 401 includes cameras 402 and 403 and pressure sensor 406. Intelligence layer 411 includes convolutional neural network 412, convolutional neural network 413, and resolution algorithm 414. Camera 402 can be a dashboard camera that streams images 432 of an upper portion of a seat to convolutional neural network 412. Camera 403 can be an under-dashboard camera that streams images 433 of a lower portion of the seat to convolutional neural network 413. Pressure sensor 406 can mounted on a dashboard and can stream sensor data 436 to resolution algorithm 414.

Convolutional neural network 412 can be an object classifier trained to classify objects as “human adult” or “not human adult”. Thus, convolutional neural network 412 can classify objects contained in streamed images 432 as “human adult” or “not human adult”. Convolutional neural network 412 can send objects classified as “human adult” or “not human adult” to resolution algorithm 414.

Convolutional neural network 413 can be an object classifier trained to classify objects as “human feet” or “not human feet”. Thus, convolutional neural network 413 can classify objects contained in streamed images 433 as “human feet” or “not human feet”. Convolutional neural network 413 can send objects classified as “human feet” or “not human feet” to resolution algorithm 414.

Resolution algorithm 414 can output various different resolutions for an object based on classification as “human adult” or “not human adult”, classification as “human feet” or “no human feet”, and sensor data from pressure sensor 406. In resolution 416, CNN 412 classifies an object as “Human Adult” and CNN 413 classifies the object as “Human Feet”. In resolution 417, CNN 412 classifies an object as “Human Adult” and CNN 413 classifies the object as “Not Human Feet”. In resolution 418, CNN 412 classifies an object as “Not Human Adult” and CNN 413 classifies the object as “Not Human Feet”.

Activation layer 421 includes activate airbag deployment device 422, deactivate airbag deployment 423, audio alert 424, and visual alert 426. When an object resolves to resolution 416, a controller unit (e.g., 202) can send a signal to activate airbag deployment device 422. When an object resolves to resolution 417 or resolves to resolution 418, a controller unit (e.g., 202) can send a signal to deactivate airbag deployment device 423. When an object resolves to resolution 417 or to resolution 418, the controller unit (e.g., 202) can also send a request to play an audio alert 424 and/or send a request to play visual alert 426 (e.g., in a vehicle cabin).

As an alternative to control unit hosting, a learning system can be built by using a single convolutional neural network.

Also as an alternative, the pressure sensor can be removed. Convolutional neural network 412 may be able to make a classification of feet on a dashboard from streamed images 432.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can transform information between different formats, such as, for example, streamed images, sensor data, airbag deployment device activation signals, airbag deployment device deactivation signals, audio alerts, visual alerts, neural network classifications, object resolutions, etc.

System memory can be coupled to the one or more processors and can store instructions (e.g., computer-readable instructions, computer-executable instructions, etc.) executed by the one or more processors. The system memory can also be configured to store any of a plurality of other types of data generated by the described components, such as, for example, streamed images, sensor data, airbag deployment device activation signals, airbag deployment device deactivation signals, audio alerts, visual alerts, neural network classifications, object resolutions, etc.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash or other vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications, variations, and combinations are possible in light of the above teaching. Further, it should be noted that any or all of the aforementioned alternate implementations may be used in any combination desired to form additional hybrid implementations of the disclosure.

1. At a vehicle, a method comprising:
receiving sensor data from one or more sensors detecting an object in a passenger seat of the vehicle;
classifying the object as an adult human based on the sensor data;
determining if the adult human is seated in an unsafe traveling position based on the sensor data; and
controlling activation status of an airbag based on the determination.

2. The method of claim 1, wherein receiving sensor data comprises receiving: first image data from a first camera on a top portion of a vehicle dashboard, second image data from a second camera under the vehicle dashboard, and sensor data from a pressure sensor on the top portion of the vehicle dashboard.

3. The method of claim 2, wherein classifying the object as an adult human based on the sensor data comprises classifying the object as a human adult based on the first image data.

4. The method of claim 3, wherein classifying the object as a human adult comprises a convolution neural network classifying the object as a human adult based on the first image data.

5. The method of claim 2, wherein determining if the adult human is seated in an unsafe traveling position based on the sensor data comprises determining if the adult human is seated in an unsafe traveling position based on at least one of: the second image data and the sensor data.

6. The method of claim 5, wherein determining if the adult human is seated in an unsafe traveling position comprises a neural network determining if the adult human is seated in an unsafe traveling position based on at least one of: second image data and the sensor data.

7. The method of claim 2, wherein determining if the adult human is seated in an unsafe traveling position based on the sensor data comprises determining that the adult human is seated in an unsafe traveling position based on at least one of: the second image data and the sensor data; and
wherein controlling activation of an airbag based on the determination comprises sending a deactivation signal to an airbag deployment device.

8. A method at a vehicle for controlling the activation status of an airbag, the method comprising:
receiving a first image stream from a first camera directed at an upper portion of a seat in a vehicle cabin;
determining the height of an object in the seat based on content in the first image stream;
receiving a second image stream from a second camera directed at a lower portion of the seat near the foot well of the vehicle;
determining if one or more other objects classified as feet are detected in front of the lower portion of the seat based on content in the second image stream;
receiving data from a pressure sensor in the dashboard of the vehicle;
determining if an object is present on the dashboard based on the sensor data;
setting the activation status of an airbag deployment device based on the height of the object, if other objects classified as feet are detected, and if an object is detected on the dashboard.

9. The method of claim 8, wherein determining the height of an object in the seat based on content in the first image stream comprises a convolutional neural network determining if an adult human is in the seat.

10. The method of claim 8, wherein determining if one or more other objects classified as feet are detected in front of the lower portion of the seat comprises a convolutional neural network detecting that human feet are not present in front of the lower portion of the seat; and
wherein setting the activation status of an airbag deployment device comprises sending a deactivation signal to the airbag deployment device.

11. The method of claim 8, wherein determining the height of an object in the seat based on content in the first image stream comprises a first convolutional neural network determining that a human adult is in the seat;
wherein determining if one or more objects classified as feet are detected in front of the lower portion of the seat comprises a convolutional neural network determining that human feet are present in front of the lower portion of the seat; and
wherein setting the activation status of an airbag deployment device comprises sending an activation signal to the airbag deployment device.

12. The method as recited in claim 8, wherein determining the height of an object in the seat based on content in the first image stream comprises a convolutional neural network determining that the object is not a human adult; and
wherein setting the activation status of an airbag deployment device comprises sending a deactivation signal to the airbag deployment device.

13. The method of claim 8, wherein determining if an object is present on the dashboard based on the sensor data comprises determining that an object is present on the dashboard; and
wherein setting the activation status of an airbag deployment device comprises sending a deactivation signal to the airbag deployment device.

14. The method of claim 8, wherein setting the activation status of an airbag deployment device comprises sending a deactivation signal to the airbag deployment device;
further comprising outputting an alert in the vehicle cabin; and
further comprising subsequent to outputting the alert:
detecting a human adult in the seat;
detecting that human feet are present in front of the lower portion of the seat; and
sending an activation signal to activate the airbag deployment device.

15. (canceled)

16. A vehicle, the vehicle comprising:
a first camera directed at an upper portion of a seat in the vehicle cabin;
a second camera directed at a lower portion of the seat near the floor of the vehicle cabin;
an airbag configured to protect an occupant in the seat upon deployment;
a control unit; and
the control unit storing instructions configured to:
receive a first image stream from the first camera;
classifying a first object in the seat as an adult human or not an adult human based on content in the first image stream;
receive a second image stream from the second camera;
classify any second objects in front of the lower portion of the seat as human feet or not human feet based on content in the second image stream; and
send a signal to an airbag deployment device to set the activation status of the airbag based on classification of the first object and classification of any second objects.

17. The vehicle of claim 16, further comprising a pressure sensor in a dashboard of the vehicle; and
the control unit storing instructions configured to:
receive sensor data from the pressure sensor; and
determine that an object is present on the dashboard based on the sensor data; and
wherein instructions configured to sending a signal to an airbag deployment device comprises instructions configured to send a deactivation signal to the airbag deployment device.

18. The vehicle of claim 16, wherein instructions configured to send a signal to an airbag deployment device comprise instructions configured to send a deactivation signal to the airbag deployment device; and
further comprising instructions configured to output an alert in the vehicle cabin.

19. The vehicle of claim 18, further comprising instructions configured to subsequent to output of the alert:
detect a human adult in the seat;
detect that human feet are present in front of the lower portion of the seat; and
send an activation signal to the airbag deployment device.

20. The vehicle of claim 16 wherein instructions configured to send a signal to the airbag deployment device comprise instructions configured to send an activation signal to the airbag deployment device based on classification of the first object as a human adult and classification of any second objects as human feet.

21. The vehicle of claim 16, wherein instructions configured to send a signal to the airbag deployment device comprise instructions configured to send a deactivation signal to the airbag deployment device based on detecting a human adult traveling in the seat in an unsafe position.
